(19) United States
(12) Patent Application Publication
(10) Pub. No.: US 2007/0250231 A1
(43) Pub. Date: Oct. 25, 2007

(54) METHOD AND SYSTEM FOR COLLECTING, TRANSMITTING, AND VERIFYING VEHICLE EMISSIONS TESTING DATA

(75) Inventors: Robert J. Tefft, Crestwood, KY (US); S. Jay Gordon JR., Louisville, KY (US); Richard W. Joy, Louisville, KY (US)

Correspondence Address: STITES & HARBISON, PLLC, 400 W MARKET ST, SUITE 1800, LOUISVILLE, KY, 40202-3352, US

(73) Assignee: Gordon-Darby Systems, Inc., Louisville, KY (US)

(21) Appl. No.: 11/379,296

(22) Filed: Apr. 19, 2006

(51) Int. Cl. G01M 17/00

(52) U.S. Cl. 701/33

(57) ABSTRACT

A vehicle emissions inspection commences when a vehicle owner connects an OBD scanning device to the OBDII system of the vehicle. Once the OBD scanning device is connected, it interrogates the vehicle to solicit the necessary information and data from the OBDII system of the vehicle. After the necessary information and data has been collected from the vehicle's OBDII system, it is encoded and encrypted into a alphanumeric character string displayed on the OBD scanning device. This alphanumeric character string is then reported to a central data storage location for evaluation and determination as to whether the inspection was valid and whether the vehicle passed or failed its inspection.

### BACKGROUND OF THE INVENTION

The present invention relates to a method and system for vehicle emissions testing, and, more particularly, to a decentralized method and system that uses the On-Board Diagnostics system of the vehicle to be tested, a method and system that combines the security and reliability of centralized emissions testing with the convenience of decentralized testing programs, specifically allowing for remote “self-inspections” of a vehicle by the vehicle owner at any time and at a location of the owner's choosing.

Vehicle emissions have long been identified as a major contributor to air pollution. As such, in geographical areas having particularly poor air quality, the United States Government, through the Environmental Protection Agency (“EPA”), has mandated vehicle emission Inspection and Maintenance (“I/M”) programs. Such I/M programs are intended to improve air quality by identifying vehicles that are no longer performing acceptably, i.e., those releasing more polluting emissions than is acceptable. Vehicles identified as not performing acceptably must then be appropriately repaired.

In implementing such I/M programs, various apparatus, methods, and testing protocols have been developed and are being used across the United States. In this regard, the applicable state, local municipality, or similar governing body normally makes the decision as to which apparatus, methods, and/or protocols to employ. In most cases, the ultimate decision as to which apparatus, methods, and/or protocols to employ depends on a combination of factors, including, for example: practicality, costs, and input from interested third parties. Thus, there are often wide variations between the apparatus, methods, and/or protocols employed in different geographic areas. Such variations often result in differences in the reliability and accuracy of the testing, along with differences in the amount of labor and skill required to conduct the testing and to maintain the equipment associated with that testing.

Regardless of the specific testing method used, all I/M programs implemented to date can be classified as either centralized, decentralized, or a hybrid thereof. Centralized I/M programs require that vehicle owners take their vehicles to one of the program's centralized inspection stations. Since each inspection station in a centralized program is typically “test only” and operated either by a government body or by an independent contractor retained by a government body, the inspection stations are generally very secure and serve as a deterrent to fraudulent testing practices. The same type and brand of test apparatus is used to perform emissions testing at all centralized inspection stations, thus helping to ensure the consistency, propriety, and adequacy of all testing activities.

Notwithstanding the fraud deterrent effectiveness of centralized I/M programs, they are often criticized because the centralized inspection stations are not necessarily convenient to vehicle owners. A state, local municipality, or similar governing body may therefore decide in favor of owner convenience and opt for a decentralized emissions testing program. In a decentralized I/M program, a greater number of inspection stations are located throughout a geographic area. These inspection stations are typically located within a private business, such as a vehicle repair shop, and are administered by private citizens employed by the business. In many cases, no single central entity supplies the equipment and personnel required for the decentralized I/M program.

While decentralized testing is well suited for owner convenience, the potential for fraudulent, inconsistent, and/or inadequate testing is much greater than in a centralized program. As such, some practices have been implemented to serve as a fraud deterrent in decentralized I/M programs. For example, certification of a decentralized inspection station is often required. If a particular inspection station was found to be purposely passing non-compliant vehicles, its certification could be revoked, thereby preventing it from legally administering vehicle emissions tests. Of course, since purchasing the equipment required for vehicle emissions testing is an extremely expensive endeavor, the loss of certification serves as a severe financial disincentive to fraudulent and inadequate testing practices. Furthermore, the private business might also be stripped of other professional licenses or certifications required to operate the business, providing another disincentive to fraudulent and inadequate testing practices.

Nonetheless, even decentralized testing can still be a burden on vehicle owners, and therefore, many government bodies are exploring the possibility of implementing new inspection programs that do not require vehicles to be brought into an inspection station for periodic testing. Such testing is a possibility because of the development the second-generation On-Board Diagnostics (“OBDII”) system. Such OBDII systems are installed on all passenger cars and light duty trucks manufactured since 1996 that are authorized to be operated in the U.S. Specifically, the OBDII system is designed for communication with an electronic scanning device that is temporarily connected to the vehicle, thereby allowing for prompt and efficient identification of any vehicle components or devices that the OBDII system believes to be malfunctioning. Included among the components monitored by the OBDII system are the vehicle's evaporative and exhaust emissions control systems, the systems that are the primary focus of I/M programs and vehicle emissions testing.

Since OBDII systems are installed on all 1996 and newer passenger cars and light duty trucks, OBD testing (electronic scanning of the OBDII system) may be implemented in conjunction with centralized, decentralized, or hybrid I/M programs that have existing inspection stations. Under this inspection method, a vehicle owner would simply go to the inspection station as before and have the OBD test performed rather than the traditional tailpipe emissions test. The vehicle inspector would plug a scan tool or electronic connector to the test apparatus into the OBDII system's Diagnostic Link Connector (“DLC”) and download electronic data from the OBDII system that indicates whether the vehicle is performing within acceptable parameters.

In addition, the increased simplicity of the OBD inspection means that the amount of training and equipment needed to properly administer the test is drastically reduced. Whereas a skilled inspector with adequate training and properly maintained test equipment is required for all tailpipe emissions testing methods, anyone with an OBD scanning device and a minimal amount of instruction can perform OBD testing. This has led some government bodies to consider ways in which it might be possible to equip vehicles with OBDII systems with devices that perform remote decentralized OBD testing without the owner having to bring the vehicle into an established inspection station.

There are at least three concerns that must be overcome to enable the implementation of such remote OBD testing. First, a cost-effective technical means must be developed that would allow remote OBD testing to be performed at a reasonable cost to vehicle owners. Second, a cost-effective technical means must be developed to transmit the electronic test results to a central data storage location at a reasonable cost. Third, a method must be developed to ensure that the test is properly performed on the appropriate vehicle. There is substantial potential for fraud in an I/M program in which remote, unsupervised inspections are performed, making it imperative that adequate fraud deterrence be incorporated into any remote OBD inspection program.

U.S. patent application Ser. No. 11/054,790 (Publication No. 2005/0182537), which is also owned by the assignee of the present application, describes one remote decentralized method and system for vehicle emissions testing that uses the OBDII system of the vehicle to be tested, enables self-service inspections, and provides the security and reliability of centralized emissions testing with the convenience of decentralized testing programs. U.S. patent application Ser. No. 11/054,790 is incorporated herein by reference. Generally, as described in U.S. patent application Ser. No. 11/054,790, a remote data storage location is in communication with a plurality of decentralized inspection stations or test locations. Each inspection location is designed to allow for “self-service” inspection. In other words, a vehicle owner may conduct the testing on his own and/or with the assistance of an attendant. As such, there are one or more kiosks at each inspection location, each kiosk including all of the hardware and software necessary to carry out the testing process and to communicate test data and information to the remote storage location.

For example, as described in U.S. patent application Ser. No. 11/054,790, an exemplary kiosk may comprise a cabinet that houses the necessary testing equipment, including (a) an OBD scanning device, which is operably linked to an internal computer housed within the cabinet; and (b) a bar code scanner, which is also operably linked to the internal computer. Furthermore, the kiosk may include various other components, for example possibly such a touch screen monitor, speakers, microphone and/or keyboard, for providing instructions to and/or solicit information from the vehicle owner. The testing process commences when a vehicle arrives at a kiosk at an inspection location. Data is solicited to identify the vehicle, preferably through input of the Vehicle Identification Number (“VIN”), which can be accomplished using the bar code scanner or another provided input device. Once the vehicle attributes and the specific testing requirements for the vehicle have been derived from the VIN, the actual testing process commences, with the vehicle owner being prompted to complete certain tasks, including connecting the OBD scanning device to the DLC of the vehicle. Once the OBD scanning device is connected, it interrogates the vehicle to solicit the necessary information and data from the vehicle's OBDII system, completing the requisite testing.

Once the information and data has been solicited and acquired from the OBDII system of the vehicle, it is promptly analyzed through comparison of the solicited information and data to a knowledge base of known testing data. The purpose of this analysis is to audit the information and data, i.e., to identify whether there are any irregularities in the acquired information and data that would indicate fraud or otherwise cast doubt on the validity of the testing. Assuming there are no such irregularities, the inspection is approved, and all acquired information and data, including the identification information and the captured images of the vehicle during the testing process, are collected in an electronic “inspection record” and transmitted to the remote data storage location.

It is an object of the present invention to provide a similar remote decentralized method and system for vehicle emissions testing that uses the OBDII system of the vehicle to be tested, a method and system that combines the security and reliability of centralized OBD testing with the speed and accessibility of decentralized testing programs, while further allowing for remote “self-inspections” of a vehicle by the vehicle owner at any time and at a location of the owner's choosing.

This and other objects and advantage of the present invention will become apparent upon a reading of the following description.

### SUMMARY OF THE INVENTION

The present invention is a decentralized method and system for vehicle emissions testing that uses the OBDII system of the vehicle to be tested, a method and system that combines the security and reliability of centralized emissions testing with the convenience of decentralized testing programs, specifically allowing for remote “self-inspections” of a vehicle by the vehicle owner at any time and at a location of the owner's choosing.

A remote OBD self-inspection in accordance with the present invention commences when a vehicle owner or other responsible party connects an OBD scanning device to the DLC of a vehicle. Once the OBD scanning device is connected, it interrogates the vehicle to solicit the necessary information and data from the OBDII system of the vehicle. After the necessary information and data has been received from the vehicle's OBDII system, it is encoded and encrypted. Specifically, the collected information and data from the vehicle's OBDII system is compressed into an alphanumeric character string, referred to as an “Inspection String,” that is representative of the status of the vehicle. Furthermore, as part of such a data compression, one or more encryption algorithms may be applied, thus allowing the Inspection String to only be decrypted and evaluated at a central data storage location.

After such encoding and encryption of the collected information and data, the Inspection String is displayed on the OBD scanning device. The vehicle owner or other responsible party then records the Inspection String for subsequent communication with the central data storage location.

Following the display of the Inspection String, the OBD scanning device may also display another alphanumeric character string referred to as a “Unique String.” The Unique String is intended to uniquely identify the particular inspection. The vehicle owner or other responsible party would also record the Unique String for subsequent communication with the central data storage location.

At this time, the testing portion of the remote OBD self-inspection is completed. The OBD scanning device is disconnected, and the collected information and data must then be reported to the central data storage location. Accordingly, the vehicle owner or other responsible party must initiate communications through a standard touch-tone telephone connection (landline or mobile), a telephone connection (landline or mobile) employing voice recognition technology, an Internet connection, or similar means of electronic data transport. Once communication is established, the vehicle owner or other responsible party inputs Inspection String, Unique String, and VIN for the vehicle.

Once the Inspection String, Unique String, and VIN for a particular self-inspection has been received at the data storage location, that data must be analyzed. First, with respect to the Unique String, a determination is made as to whether the Unique String has been used before. If so, the vehicle owner or other responsible party is informed that the test results are invalid and that a new self-inspection is required, at which time the analysis ends.

If the Unique String has not been previously used, the Inspection String is then decrypted (if necessary) and evaluated. The purpose of such an evaluation is to audit the information and data, i.e., to identify whether there are any irregularities in the acquired information and data that would indicate fraud or otherwise cast doubt on the validity of the Inspection String. If the Inspection String is not confirmed to be valid, the vehicle owner or other responsible party is informed that the test results are invalid and that a new self-inspection is required.

If the Inspection String is valid, the self-inspection is approved, and all acquired information and data, including OBDII system status and vehicle identification information, is collected in an electronic inspection record and stored in a database at the central data storage location. The OBD status data and information are also used to determine whether the vehicle passed or failed its inspection. The passing or failing emissions test results are then provided to the vehicle owner or other responsible party. Finally, inspection records, individually or in batches, may be transmitted to the department of motor vehicles or similar govenmental body.

### DESCRIPTION OF THE DRAWINGS

FIG. 1 is a schematic view of an exemplary implementation of the method and system of the present invention, illustrating a plurality of OBD scanning devices that vehicle owners or other responsible parties will use at chosen locations to perform a remote OBD self-inspection;

FIG. 2 is a block diagram illustrating the primary components of an exemplary scanning device used in the method and system of the present invention;

FIG. 3 is a perspective view of an exemplary scanning device used in the method and system of the present invention;

FIG. 4 is a perspective view of an exemplary scanning device of FIG. 3, displaying an Inspection String;

FIG. 5 is a perspective view of an exemplary scanning device of FIG. 3, displaying a Unique String; and

FIGS. 6 and 7 are flow charts illustrating the general functionality of an exemplary implementation of the method and system of the present invention.

### DETAILED DESCRIPTION OF THE INVENTION

The present invention is a decentralized method and system for vehicle emissions testing that uses the OBDII system of the vehicle to be tested, a method and system that combines the security and reliability of centralized emissions testing with the convenience of decentralized testing programs, specifically allowing for remote “self-inspections” of a vehicle by the vehicle owner at any time and at a location of the owner's choosing.

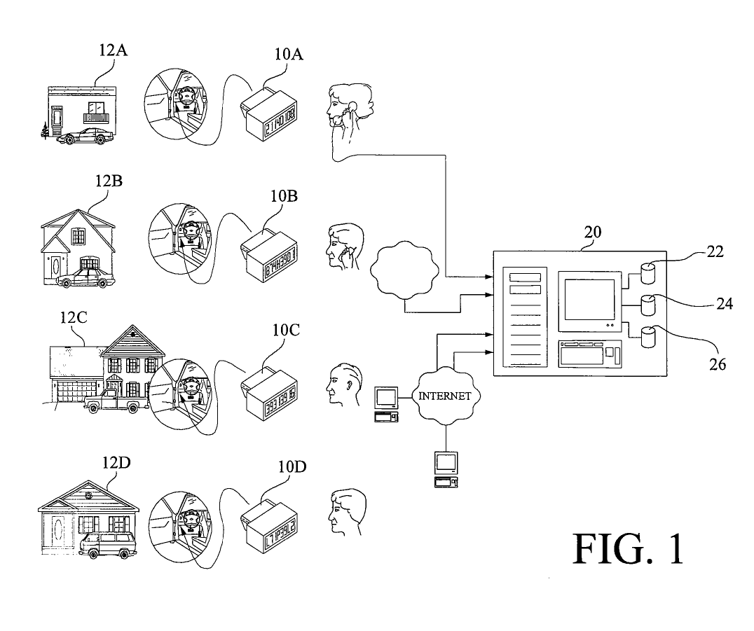

FIG. 1 is a schematic view of an exemplary implementation of the method and system of the present invention, illustrating a plurality of OBD scanning devices 10A, 10B, 10C, 10D that vehicle owners or other responsible parties will use at chosen locations 12A, 12B, 12C, 12D to perform a remote OBD self-inspection. With respect to the chosen location, because no specialized equipment is required aside from the OBD scanning devices 10A, 10B, 10C, 10D, a vehicle owner or other responsible party may conduct the testing at almost any location and any time without assistance, thus the characterization of the inspection as a “self-inspection.” Of course, it should be recognized that although four OBD scanning devices 10A, 10B, 10C, 10D and four locations 12A, 12B, 12C, 12D are illustrated in FIG. 1 for purposes of example, any number or combination of OBD scanning devices, inspectors, and/or locations could be incorporated in to the method and system of the present invention without departing from the spirit and scope of the present invention.

Once such a remote OBD self-inspection is completed, the vehicle owners or other responsible parties communicate the results of the inspection to a central data storage location 20. As illustrated in FIG. 1, it is contemplated that such a central data storage location 20 is a computer server. Furthermore, and as also illustrated in FIG. 1, it is contemplated that such communications to the central data storage location 20 are accomplished through a standard touch-tone telephone connection (landline or mobile), a telephone connection (landline or mobile) employing voice recognition technology, an Internet connection, or similar means of electronic data transport. However, no real-time or other direct connection is required between each OBD scanning device 10A, 10B, 10C, 10D and the central data storage location 20, as will be further described below.

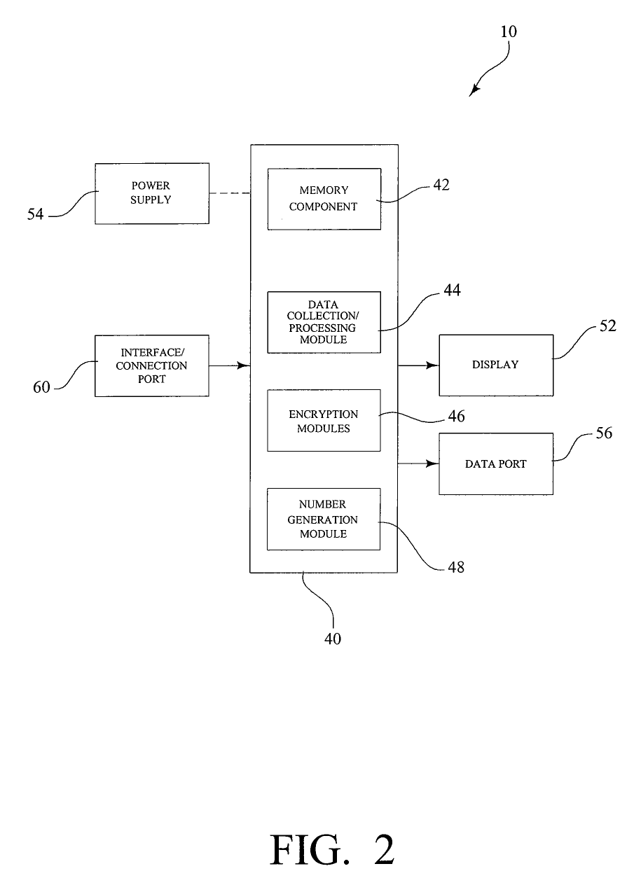

With respect to the OBD scanning devices 10A, 10B, 10C, 10D, FIG. 2 is a block diagram illustrating the primary components of an exemplary scanning device 10. First and foremost, the exemplary scanning device 10 is essentially a simple computer, and thus includes a microprocessor 40 that executes software code for controlling the operation and function of the scanning device 10. Specifically, the microprocessor 40 includes three primary modules, each preferably in the form of software code—(a) a data collection/processing module 44; (b) an encryption module 46; and (c) a number generation module 48. The respective functions of these modules are described below.

Also associated with this microprocessor 40 is a memory component 42, which is not only for storing the software code for each of the modules 44, 46, 48 of the microprocessor 40, but also for storing information and data collected during the testing process. For example, one preferred memory component 42 would include a non-volatile portion for maintaining and storing the software code for the modules 44, 46, 48, and a volatile portion for storing the transient information and data collected during the testing process. Of course, various forms of known memory devices could also be used and incorporated into the scanning device without departing from the spirit and scope of the present invention.

Referring still to FIG. 2, the scanning device 10 also includes an interface/connection port 50 designed to mate with the Diagnostic Link Connector (“DLC”) of a vehicle, placing the microprocessor 40 in electrical communication with the OBDII system of the vehicle to be tested, as will be further described below. The scanning device 10 also includes a display 52 (for example, a liquid crystal display), such that, once the OBDII system of the vehicle has been interrogated to solicit certain information and data and the requisite testing is completed, one or more alphanumeric character strings can be displayed, as will also be further described below.

Additionally, although the scanning device 10 is preferably portable or hand-held for ease of use, as illustrated in FIG. 1, other more elaborate OBD scanning devices could also be used in the method and system of the present invention. Similarly, various features could be incorporated in the OBD scanning device 10. For example, rather than operating as a passive device and using power supplied through the DLC of the vehicle to operate the microprocessor 40, the OBD scanning device 10 could include a separate battery or alternate power supply 54, as illustrated in FIG. 2, so that it could store collected information and data for a time period. For another example, and as also illustrated in FIG. 2, the OBD scanning device 10 could be provided with a data port 56 (for example, a USB or serial data port) for uploading collected information and data to another computer for subsequent data transmission, as will also be further described below.

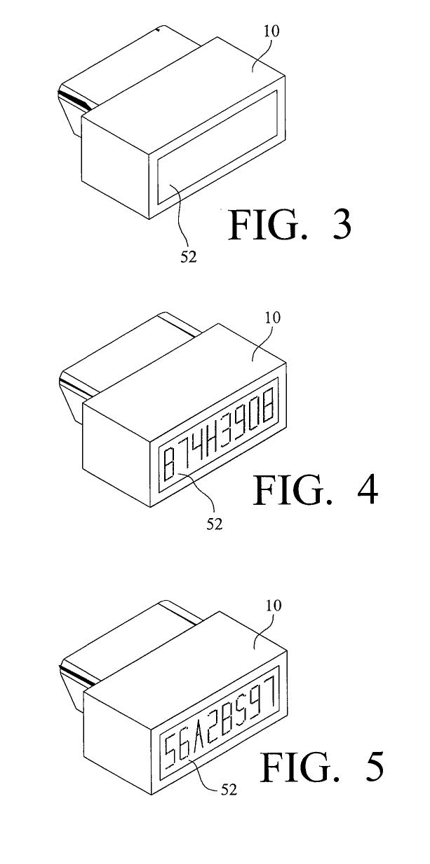

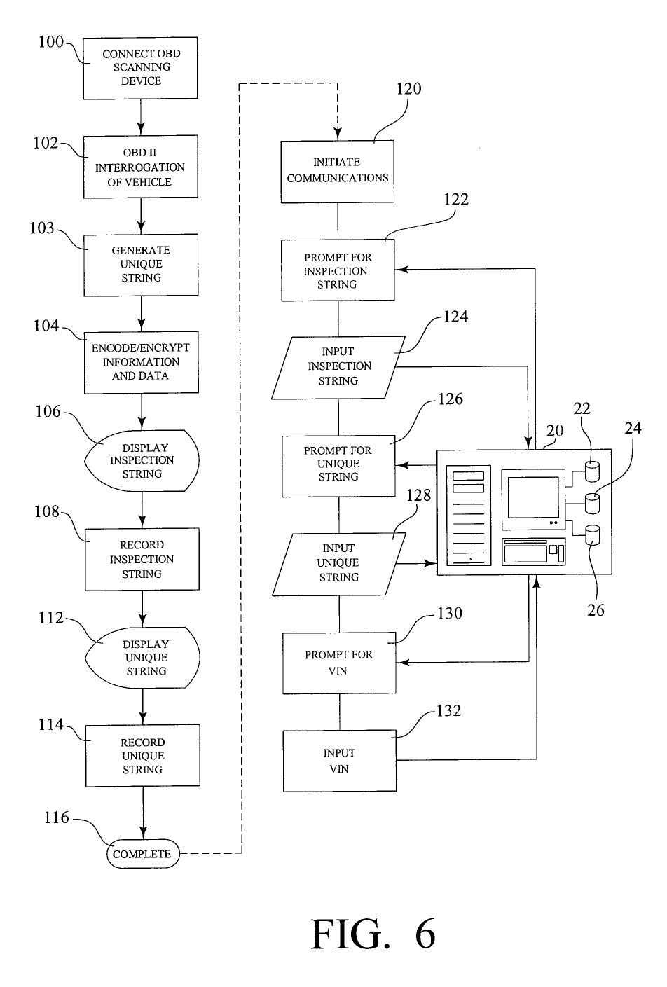

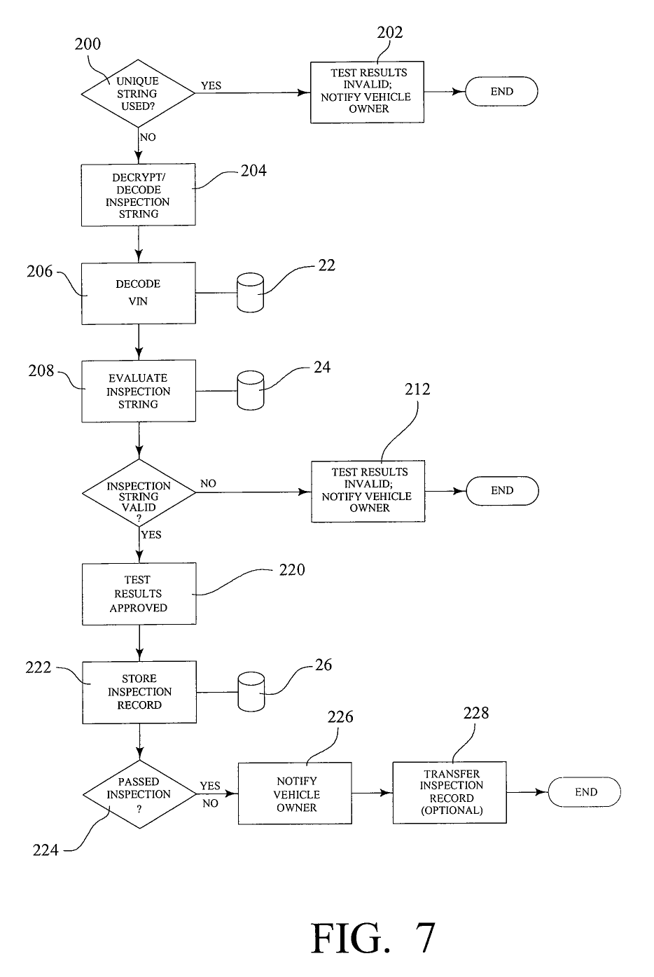

Referring now to the illustrations of an exemplary OBD scanning device 10 in FIGS. 3-5 and the flow charts of FIGS. 6 and 7, a remote OBD self-inspection in accordance with the present invention commences when a vehicle owner or other responsible party connects the OBD scanning device 10 to the DLC of a vehicle, placing the microprocessor 40 of the scanning device 10 in electrical communication with the OBDII system, as indicated by block 100 of FIG. 6. The DLC is usually located beneath the dashboard on the driver's side of the vehicle, as generally illustrated in FIG. 1, or a similar reasonably accessible location. Once the OBD scanning device 10 is connected, it interrogates the vehicle to solicit the necessary information and data from the OBDII system of the vehicle, completing the requisite testing, as indicated by block 102 of FIG. 6.

After the necessary information and data has been received from the vehicle's OBDII system and processed through the data collection/processing module 44 (FIG. 2), the OBD scanning device generates an alphanumeric character string referred to as a “Unique String,” as indicated by block 103 of FIG. 6. The Unique String is generated by the number generation module 48 (FIG. 2) and is intended to uniquely identify the particular inspection. For example, assuming that the microprocessor 40 (FIG. 2) includes a battery or on-board power supply, the number generation module 48 could include a sequential counter or an alphanumeric representation of the current date/time that would generate a portion of the Unique String, while an identification number for the particular scanning device 10 would form the remaining portion of the Unique String. Accordingly, a unique identifier would be generated each time an inspection was performed. Alternatively, in the absence of a battery or on-board power supply, the number generation module 48 could be a simple random number generator that would generate a new Unique String each time an inspection was performed. Of course, if such a random number generator was used, it would be possible for duplicate alphanumeric character strings to be generated in two separate and legitimate inspections. However, that possibility could be minimized by generating numbers within a very large range, for example, numbers having as many as seventeen digits (which is also the length of a VIN).

Then, the collected information and data is encoded and encrypted, as indicated by block 104 of FIG. 6. Specifically, the collected information and data from the vehicle's OBDII system is compressed into another alphanumeric character string, referred to as an “Inspection String,” that is representative of the status of the vehicle, including whether the OBDII system considers the vehicle ready for OBD emissions testing, whether any OBDII Diagnostic Trouble Codes (“DTCs”) are stored in the OBDII system, and whether the dashboard Malfunction Indicator Light (“MIL”) has been commanded to be illuminated. Furthermore, it is contemplated that the Unique String is also factored into the generation of the Inspection String. In other words, the Inspection String would be a function not only of the collected data that is representative of the status of the vehicle, but also a function of the Unique String. Finally, as part of such a data compression, one or more encryption algorithms can be applied by the encryption module 44, thus allowing the Inspection String to be secured and only decipherable at the central data storage location 20. Such encryption provides further protection against fraudulent testing.

After such encoding and encryption of the collected information and data, the Inspection String is displayed on the display 52 of the OBD scanning device 10, as indicated by block 106 of FIG. 6. FIG. 4 is a representative example of an Inspection String displayed on the display 52 of the OBD scanning device 10 at the conclusion of the inspection. The vehicle owner or other responsible party then records the Inspection String for subsequent communication to the central data storage location 20 (FIG. 1), as indicated by block 108.

Referring again to FIG. 6, following the display of the Inspection String, the Unique String is displayed on the display 52 of the OBD scanning device 10, as indicated by block 112. FIG. 5 is a representative example of the Unique String displayed on the OBD scanning device 10. The vehicle owner or other responsible party also records the Unique String for subsequent communication with the central data storage location 20 (FIG. 1), as indicated by block 114.

At this time, the testing portion of the remote OBD self-inspection is completed, and the OBD scanning device 10 is disconnected, as indicated by block 116 of FIG. 6. Now, the collected information and data must be reported to the central data storage location 20 (FIG. 1). Accordingly, the vehicle owner or other responsible party must initiate communications through a standard touch-tone telephone connection (landline or mobile), a telephone connection (landline or mobile) employing voice recognition technology, an Internet connection, or similar means of electronic data transport, as indicated by block 120 of FIG. 6. Such forms of electronic data transport are well-developed and known to one of ordinary skill in the art. Once communication is established, the vehicle owner or other responsible party is prompted to input the Inspection String, as indicated by block 122 of FIG. 6. For example, if a standard touch-tone telephone technology is employed, a voice recording might provide such a prompt to the vehicle owner or other responsible party. If communication is initiated through an Internet connection, the vehicle owner or other responsible party may be prompted to enter the Inspection String into a field of an on-line form. The vehicle owner or other responsible party then inputs the Inspection String, as indicated by block 124.

Similarly, the vehicle owner or other responsible party will also be prompted to input the Unique String, as indicated by block 126 of FIG. 6. The vehicle owner or other responsible party then does so, as indicated by block 128. Finally, the vehicle owner or other responsible party will be prompted to input the VIN for the vehicle, as indicated by block 130 of FIG. 6. The vehicle owner or other responsible party then does so, as indicated by block 132.

With respect to the prompting and entry of the Inspection String, Unique String, and VIN, it is recognized and contemplated that multiple self-inspections could be performed at a single location, such as an auto repair shop, with the Inspection String, Unique String, and VIN for each such self-inspection being temporarily stored and maintained at an on-site data storage location. In such a scenario, the Inspection String, Unique String, and VIN for each self-inspection could be transmitted directly from the on-site data storage location to the central data storage location 20 (FIG. 1) in single or in batch transfers, in which case the above-described prompting would not be necessary.

Similarly, to the extent that the OBD scanning device 10 is provided with a data port 56, as mentioned above with reference to FIG. 2, the Inspection String, Unique String, and VIN could be uploaded to another computer with Internet connectivity for subsequent data transmission, in which case the above-described prompting would also not be necessary.

Referring now to FIG. 7, once the Inspection String, Unique String, and VIN for a particular self-inspection has been received at the data storage location 20 (FIG. 1), that data must be analyzed.

First, with respect to the Unique String, a determination is made at decision 200 as to whether the Unique String has been used before. If so, the vehicle owner or other responsible party is informed that the test results are invalid and that a new self-inspection is required, as indicated by block 202, at which time the analysis ends.

If the Unique String has not been previously used, the Inspection String is then decrypted (if necessary) and evaluated. Specifically, the same encryption algorithms that were applied by the OBD scanning device 10 are used to reverse encryption of the Inspection String, as indicated by block 204. At the same time, the VIN may be interpreted, as indicated by block 206, with the resulting decoded information being compared to a vehicle information database 22 (as also illustrated in FIG. 1). Through such comparison, the vehicle can be properly identified, and certain vehicle attributes can be derived.

The Inspection String then may be evaluated in comparison to a knowledge base 24 of known testing data (as also illustrated in FIG. 1), as indicated by block 208 of FIG. 7, while also taking into account the vehicle attributes derived from the VIN. The purpose of such an evaluation is to audit the information and data, i.e., to identify whether there are any irregularities in the acquired information and data that would indicate fraud or otherwise cast doubt on the validity of the Inspection String. For example, it is contemplated that the number of parameter identification requests exchanged between the vehicle's OBDII system and the OBD scanning device 10 (commonly referred to as a “PID Count”) could be monitored in order to confirm that the PID Count is consistent with the year, make, and model of the vehicle. Of course, this is but one example of identifying testing irregularities, and various other acquired information and data could be similarly analyzed to identify irregularities without departing from the spirit and scope of the present invention. Such evaluation of the Inspection String culminates in a decision as to whether the Inspection String is valid for the tested vehicle, as indicated by decision 210 of FIG. 7.

If the Inspection String is not confirmed to be valid, the vehicle owner or other responsible party is informed that the test results are invalid and that a new self-inspection is required, as indicated by block 212, at which time the analysis ends.

If the Inspection String is valid, the self-inspection is approved, as indicated at block 220 of FIG. 7, and all acquired information and data, including OBDII system status and vehicle identification information, is collected in an electronic inspection record and stored in a database 26 (as also illustrated in FIG. 1) at the central data storage location 20 (FIG. 1) in, as indicated at block 222. The OBD status data and information are also used, as indicated at decision 224, to determine whether the vehicle passed or failed its inspection. The passing or failing emissions test results are then provided to the vehicle owner or other responsible party, as indicated at block 226.

Finally, as a further, optional step, inspection records, individually or in batches, are transmitted, as indicated by block 228, to the department of motor vehicles or similar governmental body.

One of ordinary skill in the art will also recognize that additional embodiments and implementations are possible without departing from the teachings of the present invention or the scope of the claims which follow. This detailed description, and particularly the specific details of the exemplary embodiment disclosed therein, is given primarily for clarity of understanding, and no unnecessary limitations are to be understood therefrom, for modifications will become obvious to those skilled in the art upon reading this disclosure and may be made without departing from the spirit or scope of the claimed invention.

1. A system for vehicle emissions testing, comprising:
at least one central data storage location; and
a plurality of OBD scanning devices, each such OBD scanning device adapted for connection to an OBDII system of a vehicle to interrogate and collect certain information and data from the OBDII system of the vehicle, and further including:
a means for encoding the collected information and data into an alphanumeric character string for subsequent evaluation at said central data storage location, and
a visual display for displaying said alphanumeric character string;
wherein, once certain information and data has been collected from the OBDII system of the vehicle as part of an inspection and said alphanumeric character string has been displayed on said visual display, said alphanumeric character string can be recorded and communicated to said central data storage location for evaluation to determine (a)whether the inspection was valid, and (b) whether the vehicle passed or failed the inspection.

2. The system for vehicle emissions testing as recited in claim 1, wherein said evaluation to determine whether the inspection was valid is based on a comparison of the information and data represented by said alphanumeric character string to a knowledge base of known testing data to identify whether there are any irregularities in the information and data that would indicate fraud.

3. The system for vehicle emissions testing as recited in claim 1, wherein each OBD scanning device further includes a means for encrypting said alphanumeric character string prior to displaying it, such that said alphanumeric character string can only be decrypted and evaluated at said central data storage location.

4. The system for vehicle emissions testing as recited in claim 1, wherein each OBD scanning device further includes a means for generating a second alphanumeric character string intended to uniquely identify a particular inspection, said second alphanumeric character string also being displayed on said visual display, such that it can be recorded and communicated to said central data storage location for evaluation to determine whether the inspection is valid.

5. The system for vehicle emissions testing as recited in claim 1, wherein said alphanumeric character string is communicated to said central data storage location through a telephone connection.

6. The system for vehicle emissions testing as recited in claim 1, wherein said alphanumeric character string is communicated to said central data storage location through a computer network.

7. The system for vehicle emissions testing as recited in claim 6, in which the computer network is the World Wide Web portion of the global Internet.

8. The system for vehicle emissions testing as recited in claim 1, wherein each OBD scanning device further includes a data port for uploading said alphanumeric character string to another computer for subsequent data transmission to said central data storage location.

9. A method for vehicle emissions testing, comprising the steps of:
providing at least one central data storage location;
providing an individual with an OBD scanning device adapted for connection to an OBDII system of a vehicle to perform an inspection, said OBD scanning device interrogating and collecting information and data from the vehicle, encoding the collected information and data into an alphanumeric character string for subsequent evaluation at said central data storage location, and displaying said alphanumeric character string; and
providing a means by which the individual can communicate said alphanumeric character string to said central data storage location for evaluation to determine (a)whether the inspection was valid, and (b) whether the vehicle passed or failed the inspection.

10. The method for vehicle emissions testing as recited in claim 9, wherein each OBD scanning device also encrypts said alphanumeric character string prior to displaying it, such that said alphanumeric character string can only be decrypted and evaluated at said central data storage location.

11. The method for vehicle emissions testing as recited in claim 9, wherein said evaluation to determine whether the inspection was valid is based on a comparison of the information and data represented by said alphanumeric character string to a knowledge base of known testing data to identify whether there are any irregularities in the information and data that would indicate fraud.

12. The method for vehicle emissions testing as recited in claim 9, and further comprising the step of informing the individual whether the vehicle passed or failed the inspection.

13. The method for vehicle emissions testing as recited in claim 9, wherein said means by which the individual can communicate said alphanumeric character string to said central data storage location is a telephone connection.

14. The method for vehicle emissions testing as recited in claim 9, wherein said means by which the individual can communicate said alphanumeric character string to said central data storage location is a computer network.

15. The method for vehicle emissions testing as recited in claim 14, in which the computer network is the World Wide Web portion of the global Internet

16. A method for vehicle emissions testing, comprising the steps of:
providing at least one central data storage location;
providing an individual with an OBD scanning device adapted for connection to an OBDII system of a vehicle to perform an inspection, said OBD scanning device
interrogating and collecting information and data from the vehicle,
generating a first alphanumeric character string to uniquely identify the inspection,
encoding the collected information and data into a second alphanumeric character string for subsequent evaluation at said central data storage location,
displaying said second alphanumeric character string,
displaying said first alphanumeric character string; and
providing a means by which the individual can communicate said first and second alphanumeric character strings to said central data storage location for evaluation to determine (a) whether the inspection was valid, and (b) whether the vehicle passed or failed the inspection.

17. The method for vehicle emissions testing as recited in claim 16, wherein said second alphanumeric character string is a function not only of the collected information and data, but also a function of the first alphanumeric character string that uniquely identifies the inspection.

18. The method for vehicle emissions testing as recited in claim 16, wherein said evaluation to determine whether the inspection was valid includes the following steps:
determining whether said first alphanumeric character string has been used before in another inspection; and
comparing the information and data represented by said second alphanumeric character string to a knowledge base of known testing data to identify whether there are any irregularities in the information and data that would indicate fraud.

19. The method for vehicle emissions testing as recited in claim 16, wherein said OBD scanning device encrypts said second alphanumeric character string prior to displaying it.

20. The method for vehicle emissions testing as recited in claim 16, and further comprising the step of informing the individual whether the vehicle passed or failed the inspection.

21. The method for vehicle emissions testing as recited in claim 16, wherein said means by which the individual can communicate said first and second alphanumeric character strings to said central data storage location is a telephone connection.

22. The method for vehicle emissions testing as recited in claim 16, wherein said means by which the individual can communicate said first and second alphanumeric character strings to said central data storage location is a computer network.

23. The method for vehicle emissions testing as recited in claim 22, in which the computer network is the World Wide Web portion of the global Internet

24. A scanning device adapted for connection to an OBDII system of a vehicle to perform an emissions inspection of the vehicle, wherein said scanning device:
generates a first alphanumeric character string to uniquely identify the inspection;
interrogates and collects information and data from the vehicle;
encodes the collected information and data into a second alphanumeric character string for subsequent evaluation at said central data storage location;
displays said second alphanumeric character string; and
displays said first alphanumeric character string.

25. (canceled)

26. The scanning device as recited in claim 24, wherein said second alphanumeric character string is a function not only of the solicited information and data, but also a function of the first alphanumeric character string that uniquely identifies the inspection.

27. The scanning device as recited in claim 24, wherein said scanning device encrypts said second alphanumeric character string prior to displaying it.
